(19) United States
(12) Patent Application Publication
(10) Pub. No.: US 2009/0100807 A1
(43) Pub. Date: Apr. 23, 2009

(54) Bridle keeper

(76) Inventors: Kaylen Spooner, Aqua Dulce, CA (US); Richard Spooner, Aqua Dulce, CA (US)

Correspondence Address: Cislo & Thomas LLP, 1333 2nd Street, Suite #500, Santa Monica, CA, 90401-4110, US

(21) Appl. No.: 11/977,368

(22) Filed: Oct. 23, 2007

(51) Int. Cl. B68B 1/04

(52) U.S. Cl. 54/6.1

(57) ABSTRACT

A method for producing a thermal barrier coating/environmental barrier coating system on a silicon containing material substrate includes applying an environmental barrier coating (EBC) over the silicon containing material substrate; and applying a thermal barrier coating (TBC) over the EBC. The thermal barrier coating includes a compound having a primary constituent portion and a stabilizer portion stabilizing the primary constituent. The primary constituent portion of the thermal barrier coating includes hafnia present in an amount of at least about 5 mol % of the primary constituent, and the stabilizer portion of the thermal barrier coating includes at least one metal oxide comprised of cations with a +2 or +3 valence present in the amount of about 10 to about 40 mol % of the thermal barrier coating.

### BACKGROUND OF THE INVENTION

1. Field of the Invention

This invention relates to a bridle keeper device to secure the loose ends of the straps on a horse bridle so that they do not flap. In one embodiment, the bridle keeper device is a band with a prong and one or more arms. The prong can be inserted into an adjustment hole in the free end of the bridle strap and the one or more arms are adapted to surround the free end of the bridle strap and a fixed portion of the bridle strap.

2. Description of the Related Art

A bridle is typically made of leather straps that are fastened around a horse's head for control and communication with the horse. It can be used when riding, leading, or tying the horse. The straps of a bridle are fastened with buckles to ensure a snug but comfortable fit. In general, bridles contain a bit attached to reins and are used for riding and driving or steering horses. There are several different types of bridles; for example, bit-less bridles used to train young horses or older horses; English bridles used in English riding having reins buckled together with little or no adornment; Western bridles used in Western riding with no noseband and silver or other decorative features, thin bridle leather, and split or closed style reins; double bridles, a type of English bridle that uses two bits in the mouth at once to offer precise control of the horse; and a longeing cavesson bridle used for having a horse walk, trot and/or canter in a large circle around a handler at the end of a rope that is 25 to 30 feet long. Each of the various bridles has one or more buckles to secure the components of the bridle together. Oftentimes, after buckling the bridle onto the horse, there are one or more straps of leather that hang free. This free end can flap making the horse uncomfortable and causing the horse to lose concentration. Training, exercise, and competition may be compromised as comfort and focus is important in a horse's performance. Many bridles have leather keepers to secure the free end of the flap; however, these keepers are straps of leather that stretch out after a few uses and slide off the loose end of the strap. They are also subject to slide after positioning around the free end of the flap. Thus, there is a need in the art to develop a device to secure the free end of a bridle strap that keeps the end of the bridle in place and prevents flapping.

### SUMMARY OF THE INVENTION

The present invention is a bridle keeper comprising a band with a prong and one or more arms. The prong is designed to fit into an adjustment hole or opening of the free end of a bridle strap, and the one or more arms of the band are sized and dimensional to fit around the free end of the bridle strap and a fixed portion of the bridle strap to hold the free end of the bridle strap in place. The prong may be attached perpendicular to the band and may be tubular and curved with a generally rounded end having a width greater than the width of the prong. The rounded end is sized and dimensional to engage the one or more adjustment openings on the free end of the bridle strap. In one embodiment, the one or more arms may be attached to one another to form a continuous band. In another embodiment the bridal keeper can be attached around the fixed bridle strap upon manufacturing. In yet another embodiment, the one or more arms of the band may be bendable allowing for a secure fit. In a further embodiment of the invention, the bridle keeper is preformed wherein the arms of the band are fixed in a bent position. Methods of installing the bridle keeper to secure the free end of a bridle strap are also contemplated.

### BRIEF DESCRIPTION OF THE DRAWINGS

FIG. 1 shows a bottom view of one embodiment of the bridle keeper.

FIG. 2 shows a top view of one embodiment of the bridle keeper.

FIG. 3 shows the bridle keeper in use.

FIG. 4 shows a perspective view of one embodiment of the bridle keeper.

### DETAILED DESCRIPTION OF THE INVENTION

The detailed description set forth below in connection with the appended drawings is intended as a description of exemplary embodiments and is not intended to represent the only forms in which these embodiments may be constructed and/or utilized. The description sets forth the functions and the sequence of steps for constructing and operating the exemplary embodiments. However, it is to be understood that the same or equivalent functions and sequences may be accomplished by different embodiments that are also intended to be encompassed within the spirit and scope of the specification.

The instant invention is directed to a bridle keeper to secure a free end of a bridle strap to a fixed portion of a bridle strap so as to hold the free end of the bridle strap in place and to prevent flapping. Free ends of a bridle strap are common when a user seeks to buckle a bridle securely and comfortably onto a horse's head. Each free end of the bridle strap has a number of adjustment openings that allow for buckling the bridle on the horse. If the free end of the bridle strap is not secured, it can uncomfortably flap on the horse's face. The bridle keeper of the instant invention prevents flapping and comprises a band with a prong adapted to engage an adjustment opening on the free end of the bridle strap, the band having one or more arms adapted to hold the free end of the bridle strap to the fixed portion of the bridle strap. In one embodiment, the prong is perpendicular to the band. In a preferred embodiment, the prong is tubular and may have a generally rounded end or ball-like tip so that it fits comfortably. The tip may also be curved, bent, pointed, or flattened. In yet another embodiment, the arms are bendable so that they may be attached to bridle straps having varying width and thickness. The arms may also be fixed in a bent position or may be sewn or affixed together to create a band that is continuous around the bridle strap. The bridle keeper may be made of any durable material or any combination of durable materials and may be embellished with ornamentation.

To secure the bridle keeper in place, a user may place the prong into an adjustment opening on the free end of a bridle strap. Where the one or more arms of the bridle keeper are made of malleable material, the user may bend the arms of the bridle keeper around the free end of the bridle strap and a fixed portion of the bridle strap. If the bridle keeper is preformed, the user may work the one or more arms of the bridle keeper around the free end of the bridle strap and the fixed portion of the bridle strap. The bridle keeper may also be positioned on the fixed bridle strap upon manufacturing such that the one or more arms form a continuous band. If the bridle keeper is positioned on the fixed bridle strap upon manufacturing, the one or more arms that form a continuous band may be made of leather and may be affixed around the fixed bridle strap by sewing.

The combination of the prong in an adjustment opening and the bent arms around the bridle straps serve to secure the bridle keeper on the bridle and secure the free end of the bridle strap. This prevents the bridle keeper from moving up and down the straps, and prevents the free end of the bridle strap from flapping. Application of the bridle keeper is quick and easy, and does not require special tools. In use, the inventive bridle keeper is comfortable for the horse and ensures that flapping of the free end of a bridal strap does not occur. It is possible to use one or more bridle keeper on one or more free ends with adjustment openings on the bridle.

A method of installing the bridle keeper is also contemplated. The method comprises placing the prong of the bridle keeper into an adjustment opening on the free end of a bridle strap and, where a malleable material is used, bending the arms of the bridle keeper around the free end of the bridle strap and a fixed portion of the bridle strap to hold the keeper in place. In general, once the bridle keeper is put in place, it can stay on the fixed strap of the bridle. To reposition the bridle keeper, the prong can be pulled out of the opening, and the loose end slid out of the keeper while the keeper remains on the fixed strap. If the preformed bridle keeper of the instant invention is used, the method comprises placing the prong of the bridle keeper into an adjustment opening on the free end of a bridle strap and positioning each bent arm around the free end of the bridle strap and the fixed portion of the bridle strap. The steps can be performed in any sequence, for example, positioning each bent arm can be performed before placing the prong into an adjustment opening or placing the prong into an adjustment opening can be performed before positioning each bent arm. If the arms of the bridle keeper are attached to form one continuous band, the method comprises moving the bridle keeper along the fixed portion of the strap, moving the free end of the bridle strap through the bridle keeper, and positioning the prong in an adjustment opening.

FIGS. 1, 2, and 3 illustrate the bridle keeper of the invention where a malleable material is utilized. FIG. 4 depicts a formed or preformed bridle keeper according to one embodiment of the invention.

FIG. 1 shows a bottom view of one form of the bridle keeper 10. The bridle keeper 10 comprises a prong 20 with a band 30 having two arms 40 and 50. The arms 40 and 50 are shown in a flat position and may be bent around the bridle straps when the bridle keeper 10 is in use. The prong 20 may have a tip 60 that is rounded, flat, curved, or of a shape sufficient to hold the prong in an adjustment opening in a bridle strap.

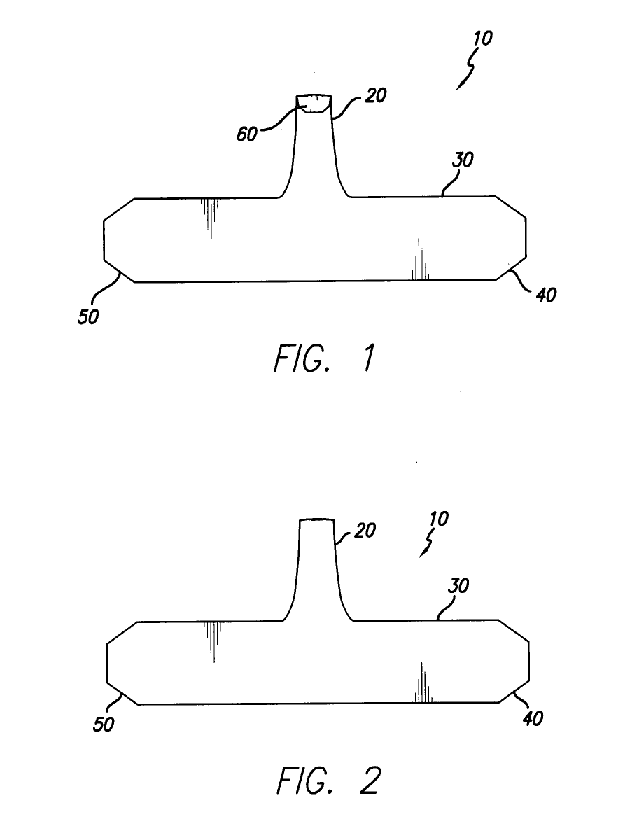

FIG. 2 shows a top view of one form of the bridle keeper 10. The bridle keeper 10 comprises a prong 20 with a band 30 having two arms 40 and 50. The arms 40 and 50 are shown in a flat position and may be bent around the bridle straps when the bridle keeper 10 is in use. The top of the prong 20 is shown, thus the tip 60 that fits into an adjustment opening in a bridle strap is concealed.

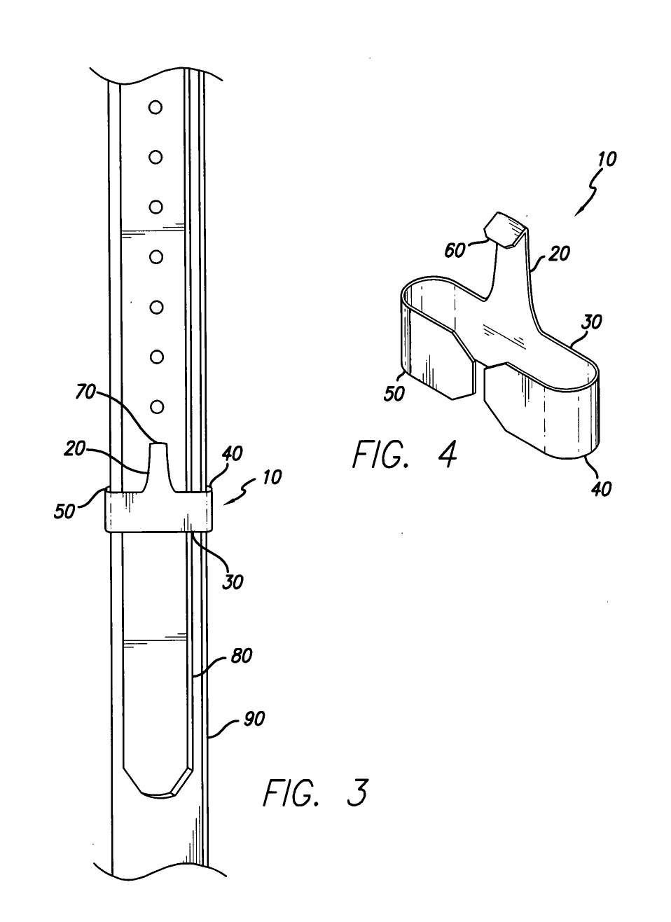

FIG. 3 shows the bridle keeper 10 in use. The prong 20 is disposed in an adjustment opening of the bridle strap 70 and the arms 40 and 50 of the band 30 are bent around the free end of the bridle strap 80 and the fixed portion of the bridle strap 90. The band 30 may have a design or other indicia.

FIG. 4 shows a perspective view of a formed or preformed bridle keeper 10. The bridle keeper 10 comprises a prong 20 with a band 30 having two arms 40 and 50. The arms 40 and 50 are shown in a bent position as they may be bent around bridle straps when the bridle keeper 10 is in use as when a malleable material is used, or as they may be positioned in the preformed bridle keeper according to one embodiment of the invention. The prong 20 may have a tip 60 that is round, ball-like, flat, curved, or of a shape sufficient to hold the prong in an adjustment opening in a bridle strap.

In one embodiment of the instant invention, the bridle keeper is made of one or more materials selected from the group consisting of metal alloy, leather, metal, aluminum, titanium, plastic, and combinations thereof. For example, the bridle keeper 20 may have a band made of leather, rubber, or metal, and a prong made of metal. Alternatively, the bridle keeper may be all one material, for example, all metal or all rubber. The bridle keeper may also be combinations of materials; for example, the band and the prong may be metal on the inside and covered with leather or rubber on the outside. The metal may be copper, titanium, tin, aluminum, steel, brass, bronze, titanium, duralumin, and combinations thereof. The bridal keeper may further be made of plastic or plastic in combination of any of the aforementioned materials. The material may have a thickness of 0.1 to 15 mm.

The band may have a width that is generally equal, meaning that it is not substantially narrow in some sections and substantially wide in some sections, and a length that is sized and dimensional to fit around the free end of the bridle strap and the fixed portion of the bridle strap. For example, the band with one or more arms may be 1.0 to 15 cm long and 0.5 to 3.0 cm wide so that the bridle keeper can be positioned on a free adjustable end of a bridle strap and a fixed portion of the bridle strap.

The prong may be tubular and positioned generally perpendicular to the band and may be of a length of 0.5 to 5.0 cm long and 0.1 to 3.0 cm wide. The prong may have a curved shape with a generally rounded end to keep it from coming out of an adjustment opening. The rounded end is sized and dimensional so as to fit through the one or more adjustment openings on the free end of the bridle strap. The generally rounded end has a width greater than the width of the tubular prong.

The bridle keeper made of a malleable material may be used over and over or it may be fixedly secured on the fixed bridle strap so that it is never removed, only slid along the strap. When retaining it on the bridle keeper, it may be slid along the fixed strap to a preferred position, the adjustable end of the bridle strap can be slid in and out of the bridle keeper, and the prong may be placed in and out of an adjustment opening. One or more bridle keeper may be used on the free adjustable end of a bridle strap.

In use, the bridle keeper made of a malleable material may be positioned by inserting the prong into an adjustable hole and bending the arms around the bridle straps. It may be removed by unbending the one or more arms and pulling the prong out of the adjustment hole. It may also be removed by keeping the one or more arms in a bent position and working the arms away from the bridle straps and pulling the prong out of the adjustment hole.

In yet another embodiment of the instant invention, the preformed bridle keeper is made of a sturdy material selected from the group consisting of leather; a metal such as copper, titanium, tin, aluminum steel, brass, bronze, titanium alloy, or duralumin; strong plastic; rubber; and combinations thereof. The tip of the prong may have a generally rounded end sized and dimensional so as to fit through the one or more adjustment openings on the free end of the bridle strap. The tip may be a ball to keep it from coming out of an adjustment opening. The preformed bridle keeper can to be used over and over. In use, the preformed bridle keeper may be positioned by working the arms around the bridle straps and inserting the prong into an adjustable hole. It may be removed by working the arms away from the bridle straps and pulling the prong out of the adjustable hole. A user may also retain the preformed bridle keeper on the fixed strap of the bridle. When retaining it on the bridle keeper, it may be slid along the fixed strap to a preferred position, the adjustable end of the bridle strap can be slid in and out of the bridle keeper, and the prong may be placed in and out of an adjustment opening.

For example, a method of using the bridle keeper may include positioning the band around the fixed end of the bridle strap, inserting the free end of the bridle strap into the band, and inserting the tubular prong into the adjustment opening in the free end of the bridle strap, wherein the tubular prong fits securely in the adjustment opening, the free end of the bridle is secured next to the fixed end of the bridle thereby eliminating any flapping, and the bridle keeper does not slide up and down the free end of the bridle strap of the fixed end of the bridle strap. The method may further comprise removing the tubular prong from the adjustment opening and sliding the bridle strap out of the band, sliding the band along the fixed portion of the bridle strap, sliding the free end of the bridle strap back into the band, and inserting the prong back into the adjustment opening.

A method may also comprise inserting the prong into one adjustment opening of the free end of the bridle strap, and positioning the one or more arms around the free end of the bridle strap and the fixed end of the bridle strap. The bridle keeper may be repositioned by removing the prong from the adjustment opening and sliding the free end of the bridle strap out of the one or more arms of the band, sliding the band along the fixed portion of the bridle strap, sliding the free end of the bridle strap back into the band, and placing the prong back into an adjustment opening

Alternatively, the bridle keeper may be affixed onto the fixed bridle strap at the time the bridle is made. For example, if the one or more arms of the bridle keeper are affixed onto the strap, they may be sewn or soldered together to form one continuous band. Preferably, the prong of the bridle keeper in such an embodiment is metal, hook-shaped, and tubular with a ball on the end to keep it from coming out of an adjustment opening. To use the affixed bridle keeper, the free end of the bridle strap is slid in the bridle keeper and the prong is placed in an adjustment opening. To remove, the prong can be pulled out and the keeper slid off of the loose end of the bridle strap and left on the fixed strap. One or more bridle keeper may be used on the free adjustable end of a bridle strap.

In all of the aforementioned embodiments, the band of the bridle keeper may have a design thereon. For example, designs may include etchings, drawings, jewels, hanging decorative items, lettering such as the name or initials of the horse, an owner, a rider, lettering of the ranch, a team name, a logo, a favorite symbol. Designs may be of a plurality of different colors.

While the present invention has been described with regards to particular embodiments, it is recognized that additional variations of the present invention may be devised without departing from the inventive concept.

1. A bridle keeper to secure a free end of a bridle strap having one or more adjustment openings to a fixed portion of the bridle strap comprising:
a band with one or more arms having a generally equal width and a length sized and dimensional to fit around the free end of the bridle strap and the fixed portion of the bridle strap; and
a tubular prong attached generally perpendicular to said band, said tubular prong having a curved shape and a generally rounded end having a width greater than the width of said tubular prong, said rounded end sized and dimensional so as to fit through the one or more adjustment openings on the free end of the bridle strap.

2. The bridle keeper of claim 1, wherein said band is leather and said prong is metal.

3. The bridle keeper of claim 1, wherein said band is rubber and said prong is metal.

4. The bridle keeper of claim 1, wherein said band is metal and said prong is metal.

5. The bridle keeper of claim 1, wherein said band is rubber and said prong is rubber.

6. The bridle keeper of claim 1, wherein said band is metal on the inside and covered with leather on the outside and said prong is metal on the inside and covered with leather on the outside.

7. The bridle keeper of claim 1, wherein said prong has a length of 0.5 to 5.0 cm long.

8. The bridle keeper of claim 1, wherein said prong has a width of 0.1 to 3.0 cm wide.

9. The bridle keeper of claim 1, wherein said width of said band is equal to 0.5 to 3.0 cm.

10. The bridle keeper of claim 1, wherein the band has a design thereon.

11. The bridle keeper of claim 1, wherein said one or more arms are in a fixed, bent position.

12. A method of using the bridle keeper of claim comprising:
positioning said band around the fixed end of the bridle strap, inserting the free end of the bridle strap into said band, and inserting said tubular prong into the adjustment opening in the free end of the bridle strap,
wherein said tubular prong fits securely in the adjustment opening, the free end of the bridle is secured next to the fixed end of the bridle thereby eliminating any flapping, and the bridle keeper does not slide up and down the free end of the bridle strap or the fixed end of the bridle strap.

13. The method of claim 12 further comprising:
removing said tubular prong from the adjustment opening and sliding the free end of the bridle strap out of said band,
sliding said band along the fixed portion of the bridle strap,
sliding the free end of the bridle strap back into said band, and
inserting said prong back into the adjustment opening.

14. A bridle keeper to secure a free end of a bridle strap having one or more adjustment openings to a fixed portion of the bridle strap comprising:
a band with one or more arms adapted to hold the free end of the bridle strap to the fixed portion of the bridle strap; and
a prong attached to said band adapted to engage the one or more adjustment openings on the free end of the bridle strap.

15. The bridle keeper of claim 14, wherein said prong is perpendicular to said band.

16. The bridle keeper of claim 14, wherein said band has a design thereon.

17. The bridle keeper of claim 14, wherein said prong is tubular and curved.

18. The bridle keeper of claim 14, wherein said prong has a generally rounded end.

19. The bridle keeper of claim 14, wherein said one or more arms are in a fixed, bent position.

20. A method of using the bridle keeper of claim 14 comprising:
inserting said prong into one adjustment opening of the free end of the bridle strap, and
positioning said one or more arms of said band around the free end of the bridle strap and the fixed portion of the bridle strap.
